(19) United States
(12) Patent Application Publication
(10) Pub. No.: US 2013/0330544 A1
(43) Pub. Date: Dec. 12, 2013

(54) METHOD FOR PRODUCING PRESSURE-SENSITIVE ADHESIVE LAYER-CARRYING OPTICAL FILM

(71) Applicant: NITTO DENKO CORPORATION, Osaka (JP)

(72) Inventors: Yuusuke Toyama, Ibaraki-shi (JP); Masakuni Fujita, Ibaraki-shi (JP); Tomoyuki Kimura, Ibaraki-shi (JP)

(21) Appl. No.: 13/910,549

(22) Filed: Jun. 5, 2013

(30) Foreign Application Priority Data
Jun. 8, 2012 (JP) 2012-131016

(51) Int. Cl. C09J 7/02; B05D 5/10; B05D 3/00

(52) U.S. Cl. CPC C09J 7/0207; B05D 3/002; B05D 5/10
USPC 428/353; 427/208.4

(57) ABSTRACT

A method for producing a pressure-sensitive adhesive layer-carrying optical film includes at least: an adhesion facilitating treatment step comprising performing an adhesion facilitating treatment on a surface of the optical film where the anchor layer is to be formed, before a step of forming the anchor layer is performed; and an application step comprising applying an anchor layer-forming coating liquid to the surface of the optical film having undergone the adhesion facilitating treatment, wherein the anchor layer-forming coating liquid contains a mixed solvent, a binder resin, and a polyoxyalkylene group-containing polymer, and the mixed solvent contains 65 to 100% by weight of water and 0 to 35% by weight of an alcohol or contains 0 to 35% by weight of water and 65 to 100% by weight of an alcohol.

### BACKGROUND OF THE INVENTION

1. Field of the Invention

The present invention relates to a method for producing a pressure-sensitive adhesive layer-carrying optical film including an optical film, an anchor layer, and a pressure-sensitive adhesive layer placed on at least one side of the optical film with the anchor layer interposed therebetween. Examples of the optical film include a polarizing film, a retardation plate, an optical compensation film, a brightness enhancement film, a surface treatment film such as an anti-reflection film, and a laminate of any combination thereof or the like.

2. Description of the Related Art

Liquid crystal display devices, organic electroluminescence (EL) display devices, etc. have an image-forming mechanism including polarizing elements as essential components. For example, therefore, in a liquid crystal display device, polarizing elements are essentially arranged on both sides of a liquid crystal cell, and generally, polarizing films are attached as the polarizing elements. Besides polarizing films, various optical elements for improving display quality have become used in display panels such as liquid crystal panels and organic EL panels. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, antiglare treatment films for preventing glare on image display devices, and anti-reflection films such as anti-reflective films and low-reflective films. These films are generically called optical films.

When such optical films are bonded to a display panel such as a liquid crystal cell or an organic EL panel or bonded to a front face plate, a pressure-sensitive adhesive is generally used. In the process of bonding an optical film to a display panel such as a liquid crystal cell or an organic EL panel or to a front face plate or bonding optical films together, a pressure-sensitive adhesive is generally used to bond the materials together so that optical loss can be reduced. In such a case, a pressure-sensitive adhesive layer-carrying optical film including an optical film and a pressure-sensitive adhesive layer previously formed on one side of the optical film is generally used, because it has some advantages such as no need for a drying process to fix the optical film.

Optical films are vulnerable to shrinkage or expansion under heating or humidifying conditions. If the adhesion between an optical film and a pressure-sensitive adhesive is low, the optical film can lift or peel from the pressure-sensitive adhesive layer. Particularly in in-vehicle applications such as car navigation systems, liquid crystal panels are required to have higher durability, and in such applications, optical films are exposed to high shrinkage stress and can more easily lift or peel. Specifically, for example, even if there is no problem in a reliability test performed at about 80° C. for TVs or the like, a problem such as lifting or peeling can easily occur in a reliability test performed at about 95° C. for in-vehicle products such as car navigation systems. After a pressure-sensitive adhesive layer-carrying optical film is bonded to a liquid crystal display, if necessary, the optical film is temporarily peeled off and then bonded again (subjected to reworking). In this process, if the adhesion between the optical film and the pressure-sensitive adhesive is low, the pressure-sensitive adhesive can remain on the surface of the liquid crystal display, so that a problem can occur in which reworking cannot be performed efficiently. Another problem can also easily occur in which if the edge of the pressure-sensitive adhesive layer-carrying optical film comes into contact with a worker or something adjacent to it in the process of cutting, feeding, or handling it, the pressure-sensitive adhesive can be chipped off of the edge portion, which can cause a display failure in the liquid crystal panel. To solve these problems, a technique for increasing adhesion between an optical film and a pressure-sensitive adhesive layer is performed, which includes applying an anchor layer to the optical film and then applying the pressure-sensitive adhesive thereto.

On the other hand, the pressure-sensitive adhesive layer is required not to cause the adhesive to form a defect in an endurance test, which is usually performed as an accelerated environmental test under heating and humidifying conditions or other conditions. Unfortunately, when an anchor layer is disposed between an optical film and a pressure-sensitive adhesive layer, there is a problem in that solvent cracking occurs on the anchor layer-coated surface side of the optical film during an endurance test. Particularly in a reliability test performed at about 95° C. for in-vehicle products such as car navigation systems, solvent cracking significantly occurs in some cases, even if no solvent cracking occurs in a reliability test performed at about 80° C. for TVs or the like.

Patent Document 1 discloses a pressure-sensitive adhesive layer-carrying optical film including an optical film, a pressure-sensitive adhesive layer, and an anchor layer interposed between the optical film and the pressure-sensitive adhesive layer, wherein the anchor layer is obtained by applying an anchor layer-forming coating liquid containing a polyamine compound and a mixed solvent of water and an alcohol and by drying the coating liquid. Concerning such a pressure-sensitive adhesive layer-carrying optical film, however, the composition of the anchor layer-forming coating liquid and the drying conditions are not specifically studied for the purpose of solving the problem of solvent cracking that occurs on the anchor layer-coated surface side of the optical film during an endurance test.

Patent Document 2 discloses a pressure-sensitive adhesive layer-carrying optical film including an optical film, a pressure-sensitive adhesive layer, and an anchor layer disposed between the optical film and the pressure-sensitive adhesive layer, wherein the anchor layer is obtained by applying an anchor layer-forming coating liquid containing an oxazoline group-containing polymer and a mixed solvent of water and an alcohol and by drying the coating liquid. Patent Document 2 also discloses a specific example in which the anchor layer-forming coating liquid is dried under the conditions of a drying temperature of 40° C. and a drying time of 120 seconds. Patent Document 3 discloses a pressure-sensitive adhesive layer-carrying optical film including an optical film, a pressure-sensitive adhesive layer, and an anchor layer disposed between the optical film and the pressure-sensitive adhesive layer, wherein the anchor layer is obtained by applying an anchor layer-forming coating liquid composed of an aqueous solution containing a polyurethane resin and a water-soluble polythiophene-based conductive polymer and by drying the coating liquid. Patent Document 3 also discloses a specific example in which the anchor layer-forming coating liquid is dried under the conditions of a drying temperature of 80° C. and a drying time of 120 seconds. However, it has been found that these drying conditions are not enough to prevent the solvent cracking described above and there is room for improvement.

Patent Document 4 discloses a pressure-sensitive adhesive layer-carrying optical film including an optical film, a pressure-sensitive adhesive layer, and an anchor layer disposed between the optical film and the pressure-sensitive adhesive layer, wherein the anchor layer is obtained by applying an anchor layer-forming coating liquid containing ammonia and an aqueous dispersion-type polymer and by drying the coating liquid. Patent Document 4 also discloses a specific example in which the anchor layer-forming coating liquid is dried under the conditions of a drying temperature of 50° C. and a drying time of 60 seconds. However, if the content of ammonia in the anchor layer is high, for example, when a polarizing film is used as the optical film, the polarizing properties of the polarizing film can change in a high-temperature or high-humidity environment. This affects the optical properties and sometimes makes it impossible to achieve high durability in a high-temperature or high-humidity environment.

As described above, the conventional techniques provide no example in which attention is focused on the problem of solvent cracking that occurs on the anchor layer-coated surface side of the optical film. To solve this problem, it is necessary to make a further study.

It is also necessary to reduce the amount of contaminants in a pressure-sensitive adhesive layer-carrying optical film because the optical film is used to form an image display device or the like. In the process of forming a pressure-sensitive adhesive layer-carrying optical film, an adhesion facilitating treatment may be performed on the surface of an optical film where an anchor layer is to be formed. Unfortunately, contaminants can be produced in the anchor layer formed after the adhesion facilitating treatment. There has been no example in which attention is focused on the problem of the contaminant production in the anchor layer. To solve this problem, it is necessary to make a further study.
[Patent Document 1] JP-A-2004-078143
[Patent Document 2] JP-A-2007-171892
[Patent Document 3] JP-A-2009-242786
[Patent Document 4] JP-A-2007-248485

### SUMMARY OF THE INVENTION

It is an object of the present invention, which has been made in view of the above state of the art, to provide a method for producing a pressure-sensitive adhesive layer-carrying optical film that includes an optical film, an anchor layer, and a pressure-sensitive adhesive layer placed on at least one side of the optical film with the anchor layer interposed therebetween, is prevented from having contaminants in the anchor layer, and has high wettability between the anchor layer and the optical film.

As a result of earnest study to solve the problems, the inventors have found that when an anchor layer-forming coating liquid is produced using a binder resin and a polyoxyalkylene group-containing polymer in combination with a mixed solvent having a specific water/alcohol ratio, the anchor layer-forming coating liquid can be highly stable so that the production of binder-derived contaminants can be suppressed, and improved wettability can be provided between the anchor layer and an optical film. The present invention, which has been accomplished as a result of the study, can achieve the object by virtue of the features described below.

Specifically, the present invention is directed to a method for producing a pressure-sensitive adhesive layer-carrying optical film including an optical film, an anchor layer, and a pressure-sensitive adhesive layer placed on at least one side of the optical film with the anchor layer interposed therebetween, the method including at least: an adhesion facilitating treatment step including performing an adhesion facilitating treatment on a surface of the optical film where the anchor layer is to be formed, before a step of forming the anchor layer is performed; and an application step including applying an anchor layer-forming coating liquid to the surface of the optical film having undergone the adhesion facilitating treatment, wherein the anchor layer-forming coating liquid contains a mixed solvent containing 65 to 100% by weight of water and 0 to 35% by weight of an alcohol or a mixed solvent containing 0 to 35% by weight of water and 65 to 100% by weight of an alcohol, a binder resin, and a polyoxyalkylene group-containing polymer.

In the method for producing a pressure-sensitive adhesive layer-carrying optical film, the binder resin is preferably a polyurethane resin binder.

In the method for producing a pressure-sensitive adhesive layer-carrying optical film, the surface of the optical film where the anchor layer is to be formed is preferably made of unsaponified triacetylcellulose.

In the method for producing a pressure-sensitive adhesive layer-carrying optical film, the application step is preferably followed by an anchor layer forming step including drying the coating liquid under conditions satisfying both of the following requirements: (1) the drying temperature T is between 40° C. and 70° C.; and (2) the value (T×H) obtained by multiplying the drying temperature T (° C.) by the drying time H (seconds) satisfies the relation 400≦(T×H)≦4,000 so that the mixed solvent is removed when the anchor layer is formed.

In the method for producing a pressure-sensitive adhesive layer-carrying optical film, there is preferably a time period of at most 30 seconds between applying the anchor layer-forming coating liquid to the optical film and starting the drying.

In another mode of the method of the present invention for producing a pressure-sensitive adhesive layer-carrying optical film, the pressure-sensitive adhesive layer-carrying optical film is a pressure-sensitive adhesive layer-carrying polarizing film.

The present invention is also directed to a pressure-sensitive adhesive layer-carrying optical film or a pressure-sensitive adhesive layer-carrying polarizing film including a product produced by the method of the present invention having any of the above features. The present invention is also directed to an image display device including such a polarizing film or such an optical film.

Generally, when an anchor layer is formed after an adhesion facilitating treatment step is performed on an optical film so that improved adhesion can be provided between the optical film and a pressure-sensitive adhesive layer, the adhesion facilitating treatment can produce oxalic acid or the like to lower the pH, which may reduce the stability of a binder resin component in an anchor layer-forming coating liquid, so that binder resin-derived contaminants may be produced. In the method of the present invention for producing a pressure-sensitive adhesive layer-carrying optical film, however, a mixed solvent with the specified water/alcohol ratio is used to form the anchor layer-forming coating liquid, so that the coating liquid can be kept stable even when the pH of the binder component is lowered. As a result, the production of binder-derived contaminants can be suppressed, so that a pressure-sensitive adhesive layer-carrying optical film prevented from having contaminants in its anchor layer can be produced. In the method of the present invention for producing a pressure-sensitive adhesive layer-carrying optical film, the anchor layer-forming coating liquid contains a polyoxyalkylene group-containing polymer, which makes it possible to produce a pressure-sensitive adhesive layer-carrying optical film having an anchor layer whose wettability with the optical film is high.

The binder resin component is preferably a polyurethane resin binder so that improved adhesion can be provided between the optical film and the pressure-sensitive adhesive layer. On the other hand, when a polyurethane resin binder is used, contaminants can be easily produced because of the effect of oxalic acid produced on the optical film by the adhesion facilitating treatment. Although the reason is not clear, it is conceivable that when an acid such as oxalic acid is produced and left, the pH of the polyurethane binder is lowered, and the stability of the coating liquid is more likely to decrease as the pH decreases, because the polyurethane binder tends to be stable under weak alkaline conditions. Particularly when a water-soluble or water-dispersible polyurethane resin binder is used, the production of contaminants tends to significantly increase as the pH decreases. In the present invention, however, a mixed solvent with the specified water/alcohol ratio is used to form the anchor layer-forming coating liquid, so that the coating liquid can be kept stable even when the pH of the binder component is lowered and even when a polyurethane resin binder, specifically, a water-soluble or water-dispersible polyurethane resin binder is used.

When the surface of the optical film where the anchor layer is to be formed is made of unsaponified triacetylcellulose, oxalic acid can be produced in a larger amount, so that contaminants can be particularly easily produced. In the present invention, however, the use of the anchor layer-forming coating liquid with the specified solvent mixture ratio makes it possible to effectively suppress the production of contaminants.

In the present invention, the anchor layer-forming coating liquid containing a mixed solvent composed mainly of water and an alcohol may be dried under conditions satisfying both of the following requirements: (1) the drying temperature T is between 40° C. and 70° C.; and (2) the value (T×H) obtained by multiplying the drying temperature T (° C.) by the drying time H (seconds) satisfies the relation 400≦(T×H)≦4,000, so that solvent cracking can be effectively prevented on the anchor layer-coated surface side of the optical film.

### DETAILED DESCRIPTION OF THE PREFERRED EMBODIMENTS

The present invention is directed to a method for manufacturing a pressure-sensitive adhesive layer-carrying optical film including an optical film, an anchor layer, and a pressure-sensitive adhesive layer placed on at least one side of the optical film with the anchor layer interposed therebetween. In the pressure-sensitive adhesive layer-carrying optical film, the pressure-sensitive adhesive layer or layers may be provided on one or both sides of the optical film.

The pressure-sensitive adhesive layer may be formed using any appropriate type of pressure-sensitive adhesive without restriction. Examples of the pressure-sensitive adhesive include a rubber-based pressure-sensitive adhesive, an acryl-based pressure-sensitive adhesive, a silicone-based pressure-sensitive adhesive, a urethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, and a cellulose-based pressure-sensitive adhesive.

Among these pressure-sensitive adhesives, those having a high level of optical transparency and weather resistance or heat resistance and exhibiting appropriate wettability and pressure-sensitive adhesive properties such as appropriate cohesiveness and tackiness are preferably used. An acryl-based pressure-sensitive adhesive is preferably used because it has such properties.

Such an acryl-based pressure-sensitive adhesive includes, as a base polymer, an acryl-based polymer having an alkyl(meth)acrylate monomer unit in its main skeleton. As used herein, the term “alkyl(meth)acrylate” means alkyl acrylate and/or alkyl methacrylate, and “(meth)” is used in the same meaning in the description. The alkyl(meth)acrylate used to form the main skeleton of the acryl-based polymer may have a straight or branched chain alkyl group of 1 to 20 carbon atoms. Examples of the alkyl(meth)acrylate include methyl(meth)acrylate, ethyl(meth)acrylate, propyl(meth)acrylate, butyl(meth)acrylate, 2-ethylhexyl (meth)acrylate, isooctyl(meth)acrylate, isononyl(meth)acrylate, isomyristyl(meth)acrylate, lauryl(meth)acrylate or the like. These may be used alone or in any combination. The average carbon number of such alkyl groups is preferably from 3 to 9.

To improve tackiness or heat resistance, one or more copolymerizable monomers may be incorporated into the acryl-based polymer by copolymerization. Examples of such copolymerizable monomers include hydroxyl group-containing monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)-methyl acrylate; carboxyl group-containing monomers such as (meth)acrylic acid, carboxyethyl(meth)acrylate, carboxypentyl(meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; and phosphate group-containing monomers such as 2-hydroxyethylacryloyl phosphate.

Examples of such monomers for modification also include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl(meth)acrylate monomers such as aminoethyl(meth)acrylate, N,N-dimethylaminoethyl(meth)acrylate, and tert-butylaminoethyl(meth)acrylate; alkoxyalkyl(meth)acrylate monomers such as methoxyethyl(meth)acrylate and ethoxyethyl(meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modifying monomers that may also be used include vinyl monomers such as vinyl acetate, vinylpropionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl(meth)acrylate; glycol acrylic ester monomers such as polyethylene glycol(meth)acrylate, polypropylene glycol(meth)acrylate, methoxyethylene glycol(meth)acrylate, and methoxypolypropylene glycol(meth)acrylate; and acrylic ester monomers such as tetrahydrofurfuryl(meth)acrylate, fluoro(meth)acrylate, silicone(meth)acrylate, and 2-methoxyethyl acrylate.

Concerning the weight ratios of all constituent monomers, the alkyl(meth)acrylate should be a main component of the acryl-based polymer, and the content of the copolymerizable monomer used to form the acryl-based polymer is preferably, but not limited to, 0 to about 20%, more preferably about 0.1 to about 15%, even more preferably about 0.1 to about 10%, based on the total weight of all constituent monomers.

Among these copolymerizable monomers, hydroxyl group-containing monomers and carboxyl group-containing monomers are preferably used in view of tackiness or durability. These monomers can serve as a reactive site to a crosslinking agent. Hydroxyl group-containing monomers and carboxyl group-containing monomers are highly reactive with intermolecular crosslinking agents and thus are preferably used to improve the cohesiveness or heat resistance of the resulting pressure-sensitive adhesive layer.

The hydroxyl group-containing monomer preferably has an alkyl group of 4 or more carbon atoms in its hydroxyalkyl group so that it can be highly reactive with the isocyanate compound (C) available as a crosslinking agent. When the hydroxyl group-containing monomer used has an alkyl group of 4 or more carbon atoms in its hydroxyalkyl group, the number of carbon atoms in the alkyl group of the alkyl(meth)acrylate to be copolymerized with the hydroxyl group-containing monomer is preferably equal to or less than the number of carbon atoms in the alkyl group of the hydroxyalkyl group. For example, when 4-hydroxybutyl(meth)acrylate is used as the hydroxyl group-containing monomer, the alkyl(meth)acrylate to be copolymerized with the hydroxyl group-containing monomer is preferably butyl(meth)acrylate or a meth)acrylate having an alkyl group in which the number of carbon atoms is smaller than the number of carbon atoms in butyl(meth)acrylate.

When a hydroxyl group-containing monomer and a carboxyl group-containing monomer are added as copolymerizable monomers, the content of the carboxyl group-containing monomer is preferably from 0.1 to 10% by weight, and the content of the hydroxyl group-containing monomer is preferably from 0.01 to 10% by weight, while these copolymerizable monomers should be used at the content described above. The content of the carboxyl group-containing monomer is more preferably from 0.2 to 8% by weight, even more preferably from 0.6 to 6% by weight. The content of the hydroxyl group-containing monomer is more preferably from 0.01 to 5% by weight, even more preferably from 0.05 to 1% by weight.

While the average molecular weight of the acryl-based polymer is not restricted, it preferably has a weight average molecular weight of about 300,000 to about 2,500,000. The acryl-based polymer may be produced by any of various known methods. For example, a radical polymerization method such as a bulk polymerization method, a solution polymerization method, or a suspension polymerization method may be appropriately selected. Any of various known radical polymerization initiators such as azo initiators and peroxide initiators may be used. The reaction is generally performed at a temperature of about 50 to about 80° C. for a time period of 1 to 8 hours. Among these production methods, a solution polymerization method is preferred, in which ethyl acetate, toluene, or the like is usually used as a solvent for the acryl-based polymer. The solution usually has a concentration of about 20 to about 80% by weight.

The pressure-sensitive adhesive is preferably a pressure-sensitive adhesive composition containing a crosslinking agent. A polyfunctional compound may be added to the pressure-sensitive adhesive, and such a compound may be an organic crosslinking agent or a polyfunctional metal chelate. Examples of the organic crosslinking agent include an epoxy crosslinking agent, an isocyanate crosslinking agent, an imine crosslinking agent, a peroxide crosslinking agent or the like. These crosslinking agents may be used singly or in combination of two or more. The organic crosslinking agent is preferably an isocyanate crosslinking agent. The polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include an alkyl ester, an alcohol compound, a carboxylic acid compound, an ether compound, and a ketone compound.

In general, the blending ratio of the crosslinking agent to the base polymer such as the acryl-based polymer is preferably, but not limited to, about 0.001 to 20 parts by weight, more preferably 0.01 to 15 parts by weight of the crosslinking agent (on a solid basis) to 100 parts by weight of the base polymer (on a solid basis). The crosslinking agent is preferably an isocyanate crosslinking agent. The amount of the isocyanate crosslinking agent is preferably from about 0.001 to about 2 parts by weight, more preferably from about 0.01 to about 1.5 parts by weight, based on 100 parts by weight of the base polymer (on a solid basis).

If necessary, the pressure-sensitive adhesive may further contain a tackifier, a plasticizer, a filler of glass fibers, glass beads, metal powder, or any other inorganic powder, a pigment, a colorant, a filler, an antioxidant, an ultraviolet absorber, a silane coupling agent, or other various additives, as long as the object of the present invention is achieved. Fine particles may also be added to the pressure-sensitive adhesive so that a pressure-sensitive adhesive layer with light diffusion properties can be formed.

Conventionally known silane coupling agents may be used without restriction. Examples include epoxy group-containing silane coupling agents such as γ-glycidoxypropyltrimethoxysilane, γ-glycidoxypropyltriethoxysilane, γ-glycidoxypropylmethyldiethoxysilane, and 2-(3,4-epoxycyclohexyl)ethyltrimethoxysilane; amino group-containing silane coupling agents such as 3-aminopropyltrimethoxysilane, N-2-(aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatopropyltriethoxysilane. A silane coupling agent in the pressure-sensitive adhesive layer may promote solvent cracking on the anchor layer-coated surface side of the optical film. Thus, the content of the silane coupling agent (on a solid basis) is preferably as low as possible based on 100 parts by weight of the base polymer (on a solid basis). More specifically, the content of the silane coupling agent is preferably from 0 to about 3 parts by weight, more preferably from 0 to about 2 parts by weight, even more preferably from 0 to about 1 part by weight, based on 100 parts by weight of the base polymer.

The method of the present invention for producing a pressure-sensitive adhesive layer-carrying optical film includes at least an adhesion facilitating treatment step including performing an adhesion facilitating treatment on a surface of an optical film where an anchor layer is to be formed, before an anchor layer forming step is performed; and an application step including applying an anchor layer-forming coating liquid to the surface of the optical film having undergone the adhesion facilitating treatment, wherein the anchor layer-forming coating liquid contains a mixed solvent containing 65 to 100% by weight of water and 0 to 35% by weight of an alcohol or a mixed solvent containing 0 to 35% by weight of water and 65 to 100% by weight of an alcohol, a binder resin, and a polyoxyalkylene group-containing polymer.

For example, the adhesion facilitating treatment may be a corona treatment or a plasma treatment. When a corona treatment or a plasma treatment is performed on the surface of the optical film where an anchor layer is to be formed, the optical film can have improved adhesion to the pressure-sensitive adhesive layer. The adhesion facilitating treatment performed on the surface of the optical film where the anchor layer is to be formed can produce oxalic acid and the like. Although not clearly understood, the mechanism of the production of oxalic acid and the like seems to be as follows.

(A) When an electrical discharge is performed for the adhesion facilitating treatment, high-energy electrons and ions collide with the surface of the optical film, so that radicals and ions are produced on the surface of the optical film.
(B) The radicals and the ions react with the surrounding molecules such as N₂, O₂, and H₂, so that a polar reactive group such as a carboxyl group, a hydroxyl group, or a cyano group is introduced, and at the same time, oxalic acid is produced. If the anchor layer-forming coating liquid is contaminated with the produced oxalic acid, the pH of the coating liquid will decrease, so that the production of contaminants in the coating liquid will increase as mentioned above.

The anchor layer-forming coating liquid contains a mixed solvent. The mixed solvent contains 65 to 100% by weight of water and 0 to 35% by weight of an alcohol or contains 0 to 35% by weight of water and 65 to 100% by weight of an alcohol. With such a water/alcohol ratio in the mixed solvent, the coating liquid can be kept stable even if the pH of the binder component decreases, so that the production of contaminants in the anchor layer can be suppressed. A mixed solvent containing 65 to 100% by weight of water and 0 to 35% by weight of an alcohol (hereinafter, such a mixed solvent is also referred to as “water-rich mixed solvent”) may be particularly used in combination with a conductive polythiophene polymer as a binder component. In this case, the polythiophene polymer can have higher dispersibility in the anchor layer-forming coating liquid. This can further improve the conductivity of the anchor layer obtained after the application and drying of the anchor layer-forming coating liquid. In addition, the use of a water-rich mixed solvent can effectively prevent solvent cracking of the anchor layer. In particular, to improve the conductivity of the anchor layer, it is preferred to use a mixed solvent containing 80 to 100% by weight of water and 0 to 20% by weight of an alcohol.

On the other hand, the use of a mixed solvent containing 0 to 35% by weight of water and 65 to 100% by weight of an alcohol (hereinafter, such a solvent is also referred to as “alcohol-rich mixed solvent”) can further improve the compatibility of the anchor layer-forming coating liquid, the wettability of an optical film with the anchor layer-forming coating liquid, the adhesion of the anchor layer-forming coating liquid to an optical film, and the appearance of the anchor coating. To improve these properties, it is preferred to use a mixed solvent containing 0 to 20% by weight of water and 80 to 100% by weight of an alcohol.

At room temperature (25° C.), the alcohol is preferably hydrophilic and in particular preferably miscible in any ratio with water. Such an alcohol preferably has 1 to 6 carbon atoms. Such an alcohol more preferably has 1 to 4 carbon atoms, even more preferably 1 to 3 carbon atoms. Examples of such an alcohol include methanol, ethanol, n-propanol, isopropyl alcohol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol. Among them, ethanol and isopropyl alcohol are preferred, and isopropyl alcohol is more preferred. A single alcohol may be used, or a mixture of two or more alcohols may be used. Two or more alcohols may be mixed in any ratio. For example, a mixed alcohol of ethanol and isopropanol, which are mixed in any ratio, may be used.

If the content of a component other than water and the alcohol, such as ammonia, in the anchor layer-forming coating liquid is high, the properties of the optical film, such as the polarizing properties of a polarizing film used as the optical film, can change in a high-temperature or high-humidity environment. This affects the optical properties, so that high durability against a high-temperature or high-humidity environment cannot be achieved in some cases. Thus, the mixed solvent (the solvent with which the binder resin is diluted) in the anchor layer-forming coating liquid should be composed mainly of water and an alcohol, and more specifically, the total content of water and an alcohol in the mixed solvent is preferably 90% by weight or more. The total content of water and an alcohol in the mixed solvent is more preferably 95% by weight or more, even more preferably 99% by weight or more. Most preferably, water and an alcohol make up substantially 100% by weight of the mixed solvent.

The anchor layer-forming coating liquid may contain ammonia, which can improve the appearance or optical reliability of the anchor layer in some cases. In view of durability or prevention of solvent cracking, however, the ammonia content is preferably as low as possible. More specifically, the content of ammonia in the anchor layer-forming coating liquid is preferably less than 0.05 parts by weight, more preferably less than 0.03 parts by weight, based on 100 parts by weight of the binder resin (on a solid basis).

In the present invention, the anchor layer-forming coating liquid contains a binder resin and a polyoxyalkylene group-containing polymer together with the mixed solvent. For example, the polyoxyalkylene group-containing polymer may be a polyoxyalkylene group-containing poly(meth)acrylate including a (meth)acrylate polymer as a main chain and a polyoxyalkylene group such as a polyoxyethylene group or a polyoxypropylene group in a side chain. In view of the wettability between the anchor layer and the optical film, the content of the polyoxyalkylene group-containing polymer in the anchor layer-forming coating liquid is preferably from 0.005 to 5% by weight, more preferably from 0.01 to 3% by weight, even more preferably from 0.01 to 1% by weight, most preferably from 0.01 to 0.5% by weight.

For improvement of the anchoring strength of the pressure-sensitive adhesive, the binder resin may be typically a polyurethane resin binder such as a water-soluble or water-dispersible polyurethane resin binder, an epoxy resin binder, an isocyanate resin binder, a polyester resin binder, a polymer having an amino group in the molecule, or a resin (polymer) having an organic reactive group, such as any type of acrylic resin binder having an oxazoline group or the like. To improve the conductivity of the anchor layer, it is preferred to use a polythiophene polymer. The content of the binder resin in the anchor layer-forming coating liquid is preferably from 0.005 to 5% by weight, more preferably from 0.01 to 3% by weight, even more preferably from 0.01 to 1% by weight, most preferably from 0.01 to 0.5% by weight.

Various forms of polythiophene polymer may be used, and a water-soluble or water-dispersible polythiophene polymer is preferably used. The polythiophene polymer preferably has a polystyrene-equivalent weight average molecular weight of 400,000 or less, more preferably 300,000 or less. If the weight average molecular weight is more than the value, the polymer may tend to have an insufficient level of water solubility or water dispersibility. If the coating liquid is prepared using such a polymer, a polymer solid residue may remain in the coating liquid or may have high viscosity, so that a uniform anchor layer may tend to be difficult to form.

The term “water-soluble” refers to having a solubility of 5 g or more per 100 g of water. The water-soluble polythiophene polymer preferably has a solubility of 20 to 30 g/100 g water. The water-dispersible polythiophene polymer may be in the form of a dispersion of polythiophene polymer fine particles in water. Such an aqueous dispersion not only has low viscosity to make it easy to form a thin coating but also is advantageous in forming a uniform coating layer. Such fine particles preferably have sizes of 1 μm or less for the uniformity of the anchor layer.

The water-soluble or water-dispersible polythiophene polymer preferably has a hydrophilic functional group in its molecule. For example, the hydrophilic functional group may be sulfone, amino, amide, imino, quaternary ammonium salt, hydroxyl, mercapto, hydrazino, carboxyl, sulfate, phosphate, or a salt thereof. The introduction of the hydrophilic functional group into the molecule makes the polythiophene polymer easily water-soluble or easily water-dispersible in the form of fine particles and also makes it possible to easily prepare the water-soluble or water-dispersible polythiophene polymer.

Examples of the water-soluble or water-dispersible polythiophene polymer include Denatron series manufactured by Nagase ChemteX Corporation.

The polyurethane resin binder such as a water-soluble or water-dispersible polyurethane resin binder is preferably used because it can particularly improve the adhesion between the optical film and the pressure-sensitive adhesive layer. On the other hand, when the polyurethane resin binder is used, a reduction in the pH of the anchor layer-forming coating liquid, caused by oxalic acid production or the like, will tend to increase the production of polyurethane resin-derived contaminants. In the present invention, however, the production of such contaminants can be suppressed by adjusting, to a specific value, the water/alcohol ratio of the mixed solvent in the coating liquid.

The anchor layer-forming coating liquid may contain an optional additive. The optional additive may be a leveling agent, an anti-foaming agent, a thickener, an antioxidant, or the like. Among these additives, a leveling agent (for example, one having an acetylene skeleton) is preferred. In general, the content of any of these additives is preferably from about 0.01 to about 500 parts by weight, more preferably from 0.1 to 300 parts by weight, even more preferably from 1 to 100 parts by weight, based on 100 parts by weight of the binder resin (on a solid basis).

In the method of the present invention for producing a pressure-sensitive adhesive layer-carrying optical film, the anchor layer-forming coating liquid is preferably applied to the optical film so as to form a coating with a thickness of 20 μm or less before drying. If the coating before drying is too thick (the amount of the applied anchor layer-forming coating liquid is too large), the solvent may easily affect the coating and promote cracking. If the coating is too thin, the adhesion between the optical film and the pressure-sensitive adhesive may be insufficient, which may reduce durability. Thus, the thickness of the coating is preferably from 2 to 17 μm, more preferably from 4 to 13 μm to prevent cracking and improve durability. The coating thickness before drying can be calculated from the thickness of the anchor layer after drying and the content of the binder resin in the anchor layer-forming coating liquid. The anchor layer-forming coating liquid may be applied by any application method such as coating, dipping, or spraying without restriction.

After the application step, the method of the present invention for producing a pressure-sensitive adhesive layer-carrying optical film preferably includes an anchor layer forming step including drying the coating liquid under conditions satisfying both of the following requirements: (1) the drying temperature T is between 40° C. and 70° C.; and (2) the value (T×H) obtained by multiplying the drying temperature T (° C.) by the drying time H (seconds) satisfies the relation 400≦(T×H)≦4,000 so that the mixed solvent is removed when the anchor layer is formed.

Concerning the drying temperature T requirement (1), drying as quickly as possible is effective in preventing solvent cracking on the anchor layer-coated surface side of the optical film, but too high a drying temperature T can facilitate the degradation of the optical film. On the other hand, if the drying temperature T is too low, insufficient drying may cause degradation of the appearance of the anchor layer or may cause solvent cracking. Thus, the drying temperature T should be between 40° C. and 70° C. The drying temperature T is preferably between 45° C. and 60° C.

Concerning the requirement (2), if the value (T×H) obtained by multiplying the drying temperature T (° C.) by the drying time H (seconds) is too large, degradation of the optical film can be undesirably promoted. If the value (T×H) is too small, insufficient drying may cause degradation of the appearance of the anchor layer or may cause solvent cracking. Thus, the relation 400≦(T×H)≦4,000 should be satisfied. The requirement is preferably 500≦(T×H)≦2,900, more preferably 500≦(T×H)≦2,000, in particular, preferably 600≦(T×H)≦1,250.

If the drying time H is too long, degradation of the optical film can be undesirably promoted, and if the drying time H is too short, insufficient drying may cause degradation of the appearance of the anchor layer or may cause solvent cracking. Thus, the drying time H is preferably between 5 and 100 seconds, more preferably between 5 and 70 seconds, even more preferably between 10 and 35 seconds.

In the method of the present invention for producing a pressure-sensitive adhesive layer-carrying optical film, if there is a long time between the application of the anchor layer-forming coating liquid to the optical film and the start of the drying under the conditions described above, the appearance of the anchor layer may degrade, and solvent cracking may be promoted on the anchor layer-coated surface side of the optical film. It is not clear what promotes solvent cracking when there is a long time between the application of the anchor layer-forming coating liquid and the start of the drying. It is, however, conceivable that solvent cracking may be caused by infiltration and diffusion of the mixed solvent from the anchor layer-forming coating liquid into the polymer of the optical film. Thus, the time from the application of the anchor layer-forming coating liquid to the start of the drying is preferably as short as possible. Specifically, it is preferably 30 seconds or less, more preferably 20 seconds or less, in particular, preferably 10 seconds or less. The lower limit of it is typically, but not limited to, about 1 second in view of workability or the like.

The thickness of the anchor layer after the drying (dry thickness) is preferably from 3 to 300 nm, more preferably from 5 to 180 nm, even more preferably from 11 to 90 nm. An anchor layer with a thickness of less than 3 nm may be not enough to ensure the anchoring between the optical film and the pressure-sensitive adhesive layer. On the other hand, an anchor layer with a thickness of more than 300 nm may be too thick to have sufficient strength, so that cohesive failure can easily occur in such an anchor layer and sufficient anchoring cannot be achieved in some cases.

In general, when the surface of the optical film, on which the anchor layer is formed by applying the anchor layer-forming coating liquid, is made of norbornene resin or (meth)acrylic resin, particularly, norbornene resin, solvent cracking is more likely to occur in a reliability test at a high temperature (95° C. or higher). This may be because (1) the optical film has a glass transition temperature (Tg) close to the temperature during the test so that the optical film becomes brittle during the test and (2) large shrinkage stress is applied to the polarizing film during the test. Thus, when the product is for use in in-vehicle applications, which are required to pass a reliability test at a high temperature (95° C. or higher), the anchor layer-forming coating liquid should be dried under sophisticated conditions in the anchor layer forming step. However, the use of the above drying conditions enables effective production of a pressure-sensitive adhesive layer-carrying optical film with high crack resistance even when the surface of the optical film, on which the anchor layer is formed, is made of norbornene resin or (meth)acrylic resin.

After the anchor layer is formed on the optical film, the pressure-sensitive adhesive layer is formed on the anchor layer, so that a pressure-sensitive adhesive layer-carrying optical film is obtained. Examples of the method for depositing the pressure-sensitive adhesive layer include, but are not limited to, a method including applying a pressure-sensitive adhesive solution to the anchor layer and drying the solution, and a method including forming a pressure-sensitive adhesive layer on a release sheet and transferring the pressure-sensitive adhesive layer onto the anchor layer. The application method to be used may be roller coating such as reverse coating or gravure coating, spin coating, screen coating, fountain coating, dipping, or spraying. The pressure-sensitive adhesive layer preferably has a thickness of 2 to 150 μm, more preferably 2 to 100 μm, in particular, preferably 5 to 50 μm. If the pressure-sensitive adhesive layer is too thin, a problem such as insufficient adhesion to the anchor layer or peeling from a glass interface may easily occur. If it is too thick, a problem such as foaming of the pressure-sensitive adhesive may easily occur.

The material used to form the release sheet may be any appropriate thin material such as paper, a film of synthetic resin such as polyethylene, polypropylene, or polyethylene terephthalate, a rubber sheet, a paper sheet, a cloth, a nonwoven fabric, a net, a foam sheet, a metal foil, or a laminate of any combination thereof. If necessary, the surface of the release sheet may be subjected to an adhesion-reducing release treatment to increase the releasability from the pressure-sensitive adhesive layer, such as a silicone treatment, a long-chain alkyl treatment, or fluoridization.

It will be understood that the ability to absorb ultraviolet light may be imparted to each layer of the pressure-sensitive adhesive layer-carrying optical film obtained according to the present invention, such as the optical film or the pressure-sensitive adhesive layer, by a treatment with an ultraviolet absorber such as a salicylic ester compound, a benzophenol compound, a benzotriazole compound, a cyanoacrylate compound, or a nickel complex salt compound.

For example, the optical film used in the pressure-sensitive adhesive layer-carrying optical film according to the present invention may be a polarizing film. A polarizing film including a polarizer and a transparent protective film or films provided on one or both sides of the polarizer is generally used.

Any of various polarizers may be used without restriction. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film or may be a polyene-based oriented film such as a film of a dehydration product of polyvinyl alcohol or a dehydrochlorination product of polyvinyl chloride. In particular, a polarizer including a polyvinyl alcohol-based film and a dichroic material such as iodine is advantageous. The thickness of the polarizer is generally, but not limited to, about 3 to about 80 μm.

For example, a polarizer including a uniaxially-stretched polyvinyl alcohol-based film dyed with iodine may be produced by a process including immersing a polyvinyl alcohol film in an aqueous iodine solution to dye the film and stretching the film to 3 to 7 times the original length. If necessary, the polyvinyl alcohol-based film may be immersed in an aqueous solution of potassium iodide or the like optionally containing boric acid, zinc sulfate, zinc chloride, or the like. If necessary, the polyvinyl alcohol-based film may be further immersed in water for washing before it is dyed. If the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid, potassium iodide, or the like or in a water bath.

The material used to form the transparent protective film is typically thermoplastic resin with a high level of transparency, mechanical strength, thermal stability, water blocking properties, isotropy, etc. Examples of such thermoplastic resin include cellulose resin such as triacetylcellulose, polyester resin, polyethersulfone resin, polysulfone resin, polycarbonate resin, polyamide resin, polyimide resin, polyolefin resin, (meth)acrylic resin, cyclic polyolefin resin (norbornene resin), polyarylate resin, polystyrene resin, polyvinyl alcohol resin, and any blend thereof. The transparent protective film may be bonded to one side of the polarizer with a pressure-sensitive adhesive layer. In this case, thermosetting or ultraviolet-curable resin such as (meth)acrylic, urethane, acrylic urethane, epoxy, or silicone resin may be used to form a transparent protective film on the other side. The transparent protective film may contain any one or more appropriate additives. Examples of such an additive include an ultraviolet absorber, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, even more preferably from 60 to 98% by weight, in particular, preferably from 70 to 97% by weight. If the content of the thermoplastic resin in the transparent protective film is less than 50% by weight, high transparency and other properties inherent in the thermoplastic resin may be insufficiently exhibited.

The transparent protective film may also be the polymer film disclosed in JP-A-2001-343529 (WO01/37007), such as a film of a resin composition containing (A) a thermoplastic resin having a substituted and/or unsubstituted imide group in the side chain and (B) a thermoplastic resin having a substituted and/or unsubstituted phenyl and nitrile groups in the side chain. A specific example includes a film of a resin composition containing an alternating copolymer of isobutylene and N-methylmaleimide and an acrylonitrile-styrene copolymer. Films such as those produced by mixing and extruding the resin composition may be used. These films have a small retardation and a small photoelastic coefficient and thus can prevent polarizing films from having defects such as strain-induced unevenness. They also have low water-vapor permeability and thus have high moisture resistance.

The thickness of the transparent protective film may be determined as appropriate. Its thickness is generally from about 1 to about 500 μm in view of strength, workability such as handleability, thin layer formability, or the like. In particular, its thickness is preferably from 1 to 300 μm, more preferably from 5 to 200 μm. The transparent protective film with a thickness of 5 to 150 μm is particularly preferred.

When transparent protective films are provided on both sides of the polarizer, protective films made of the same polymer material or different polymer materials may be used on the front and back sides.

In the present invention, at least one selected from cellulose resin, polycarbonate resin, cyclic polyolefin resin, and (meth)acrylic resin is preferably used to form the transparent protective film.

Cellulose resin is an ester of cellulose and a fatty acid. Examples of such a cellulose ester resin include triacetylcellulose, diacetyl cellulose, tripropionyl cellulose, dipropionyl cellulose, etc. In particular, triacetylcellulose is preferred. Triacetylcellulose has many commercially available sources and is advantageous in view of easy availability and cost. Examples of commercially available products of triacetylcellulose include UV-50, UV-80, SH-80, TD-80U, TD-TAC, and UZ-TAC (trade names) manufactured by Fujifilm Corporation, and KC series manufactured by KONICA MINOLTA. In general, these triacetylcellulose products have a thickness direction retardation (Rth) of about 60 nm or less, while having an in-plane retardation (Re) of almost zero.

The triacetylcellulose (hereinafter also referred to as “TAC”) may be saponified, and saponified triacetylcellulose (hereinafter also referred to as “saponified TAC”) may be used to improve the adhesion to the pressure-sensitive adhesive layer, to which it is bonded. These days, however, TAC is used without being saponified (unsaponified TAC is used) in some cases for a purpose such as a reduction in the cost of manufacturing optical films. However, a pressure-sensitive adhesive layer formed directly on unsaponified TAC by applying a pressure-sensitive adhesive solution thereto can have insufficient anchoring strength because the unsaponified TAC surface has no reactive site. A pressure-sensitive adhesive on (meth)acrylic resin or norbornene resin can also have insufficient anchoring strength because such resin has low polarity. Thus, to solve the problem of insufficient anchoring strength, it is necessary to form an anchor layer on unsaponified TAC or (meth)acrylic resin or norbornene resin. Unfortunately, unsaponified TAC, which is inert, tends to repel an anchor layer-forming coating liquid, and it is difficult to form a uniform anchor layer on unsaponified TAC. Thus, when unsaponified TAC is used, an adhesion facilitating treatment is performed before the anchor layer is formed, so that the anchor layer can be uniformly formed and the pressure-sensitive adhesive layer can have improved anchoring strength. In other words, when unsaponified TAC is used, it is necessary to perform an adhesion facilitating treatment before the anchor layer is formed (similarly, it is preferred to perform an adhesion facilitating treatment on (meth)acrylic rein or norbornene resin before the anchor layer is formed). As a result of earnest study, the inventors have found that if unsaponified TAC is subjected to an adhesion facilitating treatment, the rate of occurrence of oxalic acid production may significantly increase, so that the risk of increasing the production of contaminants in the anchor layer may occur. In the present invention, however, the production of contaminants can be suppressed by adjusting, to a specific value, the water/alcohol ratio of the mixed solvent in the coating liquid, even when the anchor layer is formed on unsaponified TAC having undergone an adhesion facilitating treatment.

For example, cellulose resin films with a relatively small thickness direction retardation can be obtained by processing any of the above cellulose resins. Examples of the processing method include a method that includes laminating a common cellulose-based film to a base film, such as a polyethylene terephthalate, polypropylene, or stainless steel film, coated with a solvent such as cyclopentanone or methyl ethyl ketone, drying the laminate by heating (for example, at 80 to 150° C. for about 3 to about 10 minutes), and then peeling off the base film; and a method that includes coating a common cellulose resin film with a solution of a norbornene resin, a (meth)acrylic resin or the like in a solvent such as cyclopentanone or methyl ethyl ketone, drying the coated film by heating (for example, at 80 to 150° C. for about 3 to about 10 minutes), and then peeling off the coating.

The cellulose resin film with a relatively small thickness direction retardation to be used may be a fatty acid cellulose resin film with a controlled degree of fat substitution. Triacetylcellulose for general use has a degree of acetic acid substitution of about 2.8. Preferably, however, the degree of acetic acid substitution should be controlled to be from 1.8 to 2.7 so that the Rth can be reduced. The Rth can also be controlled to be low by adding a plasticizer such as dibutyl phthalate, p-toluenesulfonanilide, or acetyl triethyl citrate to the fatty acid-substituted cellulose resin. The plasticizer is preferably added in an amount of 40 parts by weight or less, more preferably 1 to 20 parts by weight, even more preferably 1 to 15 parts by weight, to 100 parts by weight of the fatty acid cellulose resin.

For example, the cyclic polyolefin resin is preferably a norbornene resin. Cyclic olefin resin is a generic name for resins produced by polymerization of cyclic olefin used as a polymerizable unit, and examples thereof include the resins disclosed in JP-A-01-240517, JP-A-03-14882, and JP-A-03-122137. Specific examples thereof include ring-opened (co)polymers of cyclic olefins, addition polymers of cyclic olefins, copolymers (typically random copolymers) of cyclic olefin and α-olefin such as ethylene or propylene, graft polymers produced by modification thereof with unsaturated carboxylic acids or derivatives thereof, and hydrides thereof. Examples of the cyclic olefin include norbornene monomers.

Cyclic polyolefin resins have various commercially available sources. Examples thereof include ZEONEX (trade name) and ZEONOR (trade name) series manufactured by ZEON CORPORATION, ARTON (trade name) series manufactured by JSR Corporation, TOPAS (trade name) series manufactured by Ticona, and APEL (trade name) series manufactured by Mitsui Chemicals, Inc.

The (meth)acrylic resin preferably has a glass transition temperature (Tg) of 115° C. or more, more preferably 120° C. or more, even more preferably 125° C. or more, in particular, preferably 130° C. or more. If the Tg is 115° C. or more, the resulting polarizing film can have high durability. The upper limit to the Tg of the (meth)acrylic resin is preferably, but not limited to, 170° C. or less, in view of formability or the like. The (meth)acrylic resin can form a film with an in-plane retardation (Re) of almost zero and a thickness direction retardation (Rth) of almost zero.

Any appropriate (meth)acrylic resin may be used as long as the effects of the present invention are not impaired. Examples of such a (meth)acrylic resin include poly(meth)acrylic ester such as poly(methyl methacrylate), methyl methacrylate-(meth)acrylic acid copolymers, methyl methacrylate-(meth)acrylic ester copolymers, methyl methacrylate-acrylic ester-(meth)acrylic acid copolymers, methyl(meth)acrylate-styrene copolymers (such as MS resins), and alicyclic hydrocarbon group-containing polymers (such as methyl methacrylate-cyclohexyl methacrylate copolymers and methyl methacrylate-norbornyl(meth)acrylate copolymers). Poly(C1 to C6 alkyl(meth)acrylate) such as poly(methyl(meth)acrylate) is preferred. A methyl methacrylate-based resin composed mainly of a methyl methacrylate unit (50 to 100% by weight, preferably 70 to 100% by weight) is more preferred.

Examples of the (meth)acrylic resin include ACRYPET VH and ACRYPET VRL20A each manufactured by MITSUBISHI RAYON CO., LTD., and the (meth)acrylic resins disclosed in JP-A-2004-70296 including (meth)acrylic resins having a ring structure in their molecule and high-Tg (meth)acrylic resins obtained by intramolecular crosslinking or intramolecular cyclization reaction.

Lactone ring structure-containing (meth)acrylic resins may also be used. This is because they have high heat resistance and high transparency and also have high mechanical strength after biaxially stretched.

Examples of the lactone ring structure-containing (meth)acrylic reins include the lactone ring structure-containing (meth)acrylic reins disclosed in JP-A-2000-230016, JP-A-2001-151814, JP-A-2002-120326, JP-A-2002-254544, and JP-A-2005-146084.

The lactone ring structure-containing (meth)acrylic reins preferably have a ring structure represented by the following general formula (formula 1):

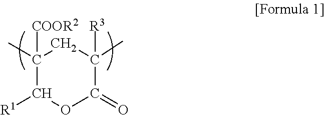

In the formula, R¹, R², and R³ each independently represent a hydrogen atom or an organic residue of 1 to 20 carbon atoms. The organic residue may contain an oxygen atom(s).

The content of the lactone ring structure represented by the general formula (formula 1) in the lactone ring structure-containing (meth)acrylic resin is preferably from 5 to 90% by weight, more preferably from 10 to 70% by weight, even more preferably from 10 to 60% by weight, in particular, preferably from 10 to 50% by weight. If the content of the lactone ring structure represented by the general formula (formula 1) in the lactone ring structure-containing (meth)acrylic resin is less than 5% by weight, the resin may have an insufficient level of heat resistance, solvent resistance, or surface hardness. If the content of the lactone ring structure represented by the general formula (formula 1) in the lactone ring structure-containing (meth)acrylic resin is more than 90% by weight, the resin may have low formability or workability.

The lactone ring structure-containing (meth)acrylic resin preferably has a mass average molecular weight (also referred to as “weight average molecular weight”) of 1,000 to 2,000,000, more preferably 5,000 to 1,000,000, even more preferably 10,000 to 500,000, in particular, preferably 50,000 to 500,000. Mass average molecular weights outside the above range are not preferred in view of formability or workability.

The lactone ring structure-containing (meth)acrylic resin preferably has a Tg of 115° C. or more, more preferably 120° C. or more, even more preferably 125° C. or more, in particular, preferably 130° C. or more. For example, if a transparent protective film made of such a resin with a Tg of 115° C. or more is incorporated into a polarizing film, the polarizing film will have high durability. The upper limit to the Tg of the lactone ring structure-containing (meth)acrylic resin is preferably, but not limited to, 170° C. or less, in view of formability or other properties.

An injection-molded product of the lactone ring structure-containing (meth)acrylic resin preferably has a total light transmittance as high as possible, preferably of 85% or more, more preferably of 88% or more, even more preferably of 90% or more, as measured by the method according to ASTM-D-1003. The total light transmittance is a measure of transparency, and a total light transmittance of less than 85% may mean lower transparency.

The transparent protective film to be used generally has an in-plane retardation of less than 40 nm and a thickness direction retardation of less than 80 nm. The in-plane retardation Re is expressed by the equation Re=(nx−ny)×d. The thickness direction retardation Rth is expressed by the equation Rth=(nx−nz)×d. The Nz coefficient is expressed by the equation Nz=(nx−nz)/(nx−ny). (In the equations, nx, ny, and nz represent the refractive indices of the film in the directions of its slow axis, fast axis, and thickness, respectively, and d (nm) represents the thickness of the film. The direction of the slow axis is a direction in which the in-plane refractive index of the film is maximum.) The transparent protective film is preferably as colorless as possible. The protective film to be used preferably has a retardation of −90 nm to +75 nm in its thickness direction. When the protective film used has a retardation (Rth) of −90 nm to +75 nm in its thickness direction, transparent protective film-induced coloration of the polarizing film (optical coloration) can be substantially avoided. The retardation (Rth) in the thickness direction is more preferably from −80 nm to +60 nm, in particular, preferably from −70 nm to +45 nm.

Alternatively, the transparent protective film to be used may be a retardation plate having an in-plane retardation of 40 nm or more and/or a thickness direction retardation of 80 nm or more. The in-plane retardation is generally controlled to be in the range of 40 to 200 nm, and the thickness direction retardation is generally controlled to be in the range of 80 to 300 nm. The use of the retardation plate as a transparent protective film makes it possible to reduce the thickness because the retardation plate also functions as a transparent protective film.

Examples of the retardation plate include a birefringent film produced by uniaxially or biaxially stretching a polymer material, an oriented liquid crystal polymer film, and an oriented liquid crystal polymer layer supported on a film. While the thickness of the retardation plate is also not restricted, it is generally from about 20 to about 150 μm.

For example, the polymer material may be polyvinyl alcohol, polyvinyl butyral, poly(methyl vinyl ether), poly(hydroxyethyl acrylate), hydroxyethyl cellulose, hydroxypropyl cellulose, methylcellulose, polycarbonate, polyarylate, polysulfone, polyethylene terephthalate, polyethylene naphthalate, polyethersulfone, polyphenylene sulfide, polyphenylene oxide, polyallylsulfone, polyamide, polyimide, polyolefin, polyvinyl chloride, cellulose resin, cyclic polyolefin resin (norbornene resin), any of various types of binary or ternary copolymers thereof and graft copolymers thereof, or any blend thereof. Any of these polymer materials can be formed into an oriented product (a stretched film) by stretching or other processes.

Examples of the liquid crystal polymer include various main-chain or side-chain types having a conjugated linear atomic group (mesogen) that is introduced in the main or side chain of the polymer to impart liquid crystal molecular orientation. Examples of main chain type liquid crystal polymers include polymers whose structure has a mesogen group bonded through a flexibility-imparting spacer moiety, such as nematically ordered polyester liquid-crystalline polymers, discotic polymers, and cholesteric polymers. Examples of side-chain type liquid crystal polymers include polymers having a main chain skeleton of polysiloxane, polyacrylate, polymethacrylate, or polymalonate and a side chain having a mesogen moiety that includes a nematic orientation-imparting para-substituted cyclic compound unit and is bonded through a spacer moiety including a conjugated atomic group. For example, any of these liquid crystal polymers may be applied by a process that includes spreading a solution of the liquid crystal polymer on an alignment surface, such as a rubbed surface of a thin film of polyimide, polyvinyl alcohol or the like formed on a glass plate, or an obliquely vapor-deposited silicon oxide surface formed on a glass plate, and heat-treating the solution.

The retardation plate may have any appropriate retardation depending on the intended purpose such as compensation for coloration, viewing angle, or the like associated with the birefringence of various wave plates or liquid crystal layers. Two or more different retardation plates may also be laminated to provide controlled optical properties such as controlled retardation.

A retardation plate that satisfies the relation nx=ny>nz, nx>ny>nz, nx>ny=nz, nx>nz>ny, nz=nx>ny, nz>nx>ny, or nz>nx=ny is selected and used depending on various applications. Herein, ny=nz means not only that ny is completely equal to nz but also that ny is substantially equal to nz.

For example, when satisfying nx>ny>nz, the retardation plate to be used preferably has an in-plane retardation of 40 to 100 nm, a thickness direction retardation of 100 to 320 nm, and an Nz coefficient of 1.8 to 4.5. For example, when satisfying nx>ny=nz, the retardation plate (positive A plate) to be used preferably has an in-plane retardation of 100 to 200 nm. For example, when satisfying nz=nx>ny, the retardation plate (negative A plate) to be used preferably has an in-plane retardation of 100 to 200 nm. For example, when satisfying nx>nz>ny, the retardation plate to be used preferably has an in-plane retardation of 150 to 300 nm and an Nz coefficient of more than 0 to 0.7. Alternatively, the retardation plate to be used may satisfy nx=ny>nz, nz>nx>ny, or nz>nx=ny, as mentioned above.

The transparent protective film may be appropriately selected depending on the liquid crystal display to be produced therewith. For example, in the case of VA (Vertical Alignment, including MVA and PVA), at least one (on the cell side) of the transparent protective films of the polarizing film should preferably has a retardation. Specifically, such a transparent protective film preferably has a retardation Re in the range of 0 to 240 nm and a retardation Rth in the range of 0 to 500 nm. In terms of three-dimensional refractive index, the relation nx>ny=nz, nx>ny>nz, nx>nz>ny, or nx=ny>nz (positive A plate, biaxial, negative C plate) is preferred. In the case of VA type, a combination of a positive A plate and a negative C plate or a single biaxial film is preferably used. When polarizing films are used on the upper and lower sides of a liquid crystal cell, the transparent protective films on the upper and lower sides of the liquid crystal cell may each have a retardation, or one of the upper and lower transparent protective films may have a retardation.

For example, in the case of IPS (In-Plane Switching, including FFS), the protective film of one of the polarizing films may have or may not have a retardation. For example, protective films with no retardation are preferably provided on both upper and lower sides of a liquid crystal cell (on the cell sides). Alternatively, protective films with a retardation are preferably provided on both upper and lower sides of a liquid crystal cell, or one of the upper and lower protective films preferably has a retardation (for example, a biaxial film satisfying the relation nx>nz>ny may be provided on the upper side, and a film with no retardation may be provided on the lower side, or a positive A plate may be provided on the upper side, and a positive C plate may be provided on the lower side). When the protective film has a retardation, it preferably has a retardation Re in the range of −500 to 500 nm and a retardation Rth in the range of −500 to 500 nm. In terms of three-dimensional refractive index, nx>ny=nz, nx>nz>ny, nz>nx=ny, or nz>nx>ny (positive A plate, biaxial, positive C plate) is preferred.

The film with a retardation may be bonded to a separate transparent protective film with no retardation, so that the retardation function can be imparted to the transparent protective film.

Before coated with an adhesive, the transparent protective film may be subjected to a surface modification treatment for improving its bondability to the polarizer.

Examples of such a treatment include a corona treatment, a plasma treatment, a flame treatment, an ozone treatment, a primer treatment, a glow treatment, a saponification treatment, and a treatment with a coupling agent. An antistatic layer may also be formed as needed.

The surface of the transparent protective film, opposite to its surface where the polarizer is to be bonded, may be subjected to hard coating, an antireflection treatment, an anti-sticking treatment, or a treatment for diffusion or antiglare purpose.

Hard coating is performed for the purpose of preventing the surface of the polarizing film from being scratched and other purposes. For example, a hard coating can be formed by a method of making a cured film with a high level of hardness and smoothness on the surface of the transparent protective film from an appropriate ultraviolet-curable resin such as an acrylic resin, a silicone resin or the like. An anti-reflection treatment is performed for the purpose of preventing reflection of external light on the polarizing film surface, and it can be achieved by forming an anti-reflection film or the like according to conventional techniques. An anti-sticking treatment is performed for the purpose of preventing the film from sticking to an adjacent layer (e.g., a diffusion plate on the backlight side).

An antiglare treatment is performed for the purpose of preventing external light from reflecting on the surface of the polarizing film and from inhibiting the view of light transmitted through the polarizing film, and other purposes. An antiglare part can be formed by providing fine irregularities on the surface of the transparent protective film by any appropriate method such as a surface roughening method such as sand blasting or embossing or a method of mixing transparent fine particles. For example, the fine particles, which are used to form the surface fine irregularities, may be optionally-conductive inorganic fine particles of silica, alumina, titania, zirconia, tin oxide, indium oxide, cadmium oxide, antimony oxide, or the like with an average particle size of 0.5 to 20 μm, or may be transparent fine particles such as organic fine particles of a crosslinked or uncrosslinked polymer or the like with an average particle size of 0.5 to 20 μm. The surface fine irregularities are generally formed using about 2 to about 70 parts by weight of the fine particles, preferably 5 to 50 parts by weight of the fine particles, based on 100 parts by weight of the transparent resin used to form the surface fine irregularities. The antiglare layer may also serve as a diffusion layer (with a viewing angle-widening function or the like) to diffuse light being transmitted through the polarizing film and to widen the viewing angle.

The anti-reflection layer, the anti-sticking layer, the diffusion layer, the antiglare layer, or the like may be provided in the transparent protective film itself, or may be provided as another optical layer independent from the transparent protective film.

The polarizer and the transparent protective film may be bonded together with an adhesive. Examples of such an adhesive include isocyanate adhesives, polyvinyl alcohol-based adhesives, gelatin-based adhesives, vinyl adhesives, latex adhesives, and aqueous polyester adhesives. The adhesive is generally used in the form of an aqueous adhesive solution, which generally has a solids content of 0.5 to 60% by weight. Besides the above, ultraviolet-curable adhesives, electron beam-curable adhesives, or the like may also be used to bond the polarizer and the transparent protective film together. Electron beam-curable adhesives for polarizing films exhibit good tackiness to the various transparent protective films described above. The adhesive for use in the present invention may also contain a metal compound filler.

Examples of the optical film also include a reflector, a transflector, a retardation plate (including a wavelength plate such as a half or quarter wavelength plate), a viewing angle compensation film, a brightness enhancement film, a surface treatment film, and any other optical layer that can be used to form a liquid crystal display device or the like. These optical components may be used alone as the optical film, or one or more layers of any of these optical components may be used with the polarizing film to form a laminate for practical use.

The surface treatment film may also be provided on and bonded to a front face plate. Examples of the surface treatment film include a hard-coat film for use in imparting scratch resistance to the surface, an antiglare treatment film for preventing glare on image display devices, and an anti-reflection film such as an anti-reflective film or a low-reflective film, etc. The front face plate is provided on and bonded to the surface of an image display device such as a liquid crystal display device, an organic EL display device, a CRT, or a PDP to protect the image display device or to provide a high-grade appearance or a differentiated design. The front face plate is also used as a support for a λ/4 plate in a 3D-TV. In a liquid crystal display device, for example, the front face plate is provided above a polarizing film on the viewer side. When the pressure-sensitive adhesive layer according to the present invention is used, the same effect can be produced using a plastic base material such as a polycarbonate or poly(methyl methacrylate) base material for the front face plate, as using a glass base material.

The optical film including a laminate of the polarizing film and the optical layer may be formed by a method of stacking them one by one in the process of manufacturing a liquid crystal display or the like. However, an optical film formed by previous lamination has the advantage that it can facilitate the process of manufacturing a liquid crystal display or the like, because it has stable quality and good assembling workability. In the lamination, any appropriate bonding means such as a pressure-sensitive adhesive layer may be used. When the polarizing film and any other optical layer are bonded together, their optical axes may be each aligned at an appropriate angle, depending on the desired retardation properties or other desired properties.

The pressure-sensitive adhesive layer-carrying optical film according to the present invention is preferably used to form a variety of image display devices such as liquid crystal display devices. Liquid crystal display devices may be formed according to conventional techniques. Specifically, a liquid crystal display device may be typically formed using any conventional technique including properly assembling a display panel such as a liquid crystal cell, a pressure-sensitive adhesive layer-carrying optical film, and optional components such as lighting system components, and incorporating a driving circuit, except that the pressure-sensitive adhesive layer-carrying optical film used is according to the present invention. The liquid crystal cell to be used may also be of any type such as TN type, STN type, n type, VA type, or IPS type.

Any desired liquid crystal display device may be formed, such as a liquid crystal display device including a display panel such as a liquid crystal cell and the pressure-sensitive adhesive layer-carrying optical film or films placed on one or both sides of the display panel or a liquid crystal display device further including a backlight or a reflector in a lighting system. In such a case, the optical film or films according to the present invention may be placed on one or both sides of a display panel such as a liquid crystal cell. When the optical films are provided on both sides, they may be the same or different. The process of forming a liquid crystal display device may also include placing an appropriate component such as a diffusion plate, an antiglare layer, an anti-reflection film, a protective plate, a prism array, a lens array sheet, a light diffusion plate, or a backlight in one or more layers at an appropriate position or positions.

Next, an organic electroluminescence device (organic EL display device or OLED) will be described. An organic EL display device generally includes a transparent substrate and a light-emitting element (an organic electroluminescence light-emitting element) that is formed on the substrate by stacking a transparent electrode, an organic light-emitting layer, and a metal electrode in this order. In this structure, the organic light-emitting layer is a laminate of different organic thin films. Concerning such a laminate, various combinations are known, such as a laminate of a hole injection layer including a triphenylamine derivative or the like and a light-emitting layer including a fluorescent organic solid material such as anthracene, a laminate of such a light-emitting layer and an electron injection layer including a perylene derivative or the like, and a laminate of the hole injection layer, the light-emitting layer, and the electron injection layer.

The organic EL display device emits light based on the mechanism that holes and electrons are injected into the organic light-emitting layer when a voltage is applied between the transparent electrode and the metal electrode, and the energy generated by the recombination of the holes and the electrons excites the fluorescent substance, so that light is emitted when the excited fluorescent substance goes back to the ground state. The mechanism of the recombination during the process is similar to that in common diodes. As expected from this feature, current and emission intensity exhibit strong nonlinearity accompanied by rectification with respect to applied voltages.

In the organic EL display device, at least one of the electrodes must be transparent for the output of the emission from the organic light-emitting layer, and a transparent electrode made of a transparent electrical conductor such as indium tin oxide (ITO) is generally used as an anode. On the other hand, to facilitate the electron injection and increase the luminous efficiency, it is important to use a low-work-function substance for the cathode, and an electrode of a metal such as Mg—Ag or Al—Li is generally used.

In the organic EL display device with such a configuration, the organic light-emitting layer is formed of a very thin film with a thickness of about 10 nm. Thus, light is almost entirely transmitted through the organic light-emitting layer, as well as through the transparent electrode. In the off-state, therefore, light incident on the surface of the transparent substrate is transmitted through the transparent electrode and the organic light-emitting layer and reflected from the metal electrode to return to and exit from the surface of the transparent substrate, so that the screen of the organic EL display looks like a mirror surface when it is viewed from the outside.

An organic EL display device having an organic electroluminescence light-emitting element including an organic light-emitting layer for emitting light upon voltage application, a transparent electrode provided on the front side of the organic light-emitting layer, and a metal electrode provided on the back side of the organic light-emitting layer may also include a polarizing film provided on the front side of the transparent electrode and a retardation plate provided between the transparent electrode and the polarizing film.

The retardation plate and the polarizing film act to polarize light that enters from the outside and is reflected from the metal electrode. Thus, their polarization action is effective in preventing the mirror surface of the metal electrode from being visible from the outside. Specifically, the retardation plate may include a quarter wavelength plate, and the angle between the polarization directions of the polarizing film and the retardation plate may be set at π/4, so that the mirror surface of the metal electrode can be completely shielded.

Of external light incident on the organic EL display device, therefore, only a linearly polarized light component is transmitted by the polarizing film. The linearly polarized light is generally turned into elliptically polarized light by the retardation plate. Particularly when the retardation plate is a quarter wavelength plate and when the angle between the polarization directions of the polarizing film and the retardation plate is π/4, the linearly polarized light is turned into circularly polarized light.

The circularly polarized light is transmitted through the transparent substrate, the transparent electrode, and the organic thin film, reflected from the metal electrode, transmitted through the organic thin film, the transparent electrode, and the transparent substrate again, and turned into linearly polarized light again by the retardation plate. The linearly polarized light has a polarization direction orthogonal to that of the polarizing film and thus cannot pass through the polarizing film. As a result, the mirror surface of the metal electrode can be completely shielded.

### EXAMPLES

Hereinafter, the present invention is more specifically described with reference to the examples, which however are not intended to limit the present invention. In each example, “parts” and “%” are all by weight, unless otherwise stated.

### Example 1

### Preparation of Optical Film (Polarizing Film)

<Polarizer>

A 75-μm-thick polyvinyl alcohol film with an average degree of polymerization of 2,400 and a degree of saponification of 99.9% by mole was immersed in warm water at 30° C. for 60 seconds so that it was allowed to swell. The film was then immersed in an aqueous solution of 0.3% iodine/potassium iodide (0.5/8 in weight ratio) and dyed while stretched to 3.5 times. The film was then stretched to a total stretch ratio of 6 times in an aqueous boric ester solution at 65° C. After the stretching, the film was dried in an oven at 40° C. for 3 minutes to give a PVA-based polarizer (23 μm in thickness).

<Transparent Protective Film>

An 80-μm-thick triacetylcellulose (TAC) film was used as a transparent protective film without being subjected to saponification, corona treatment, and other processes (hereinafter, TAC not having undergone saponification, corona treatment, and other processes is also referred to as “unsaponified TAC”).

<Active Energy Rays>

The active energy rays used were as follows: ultraviolet rays (gallium-containing metal halide lamp); irradiator, Light Hammer 10 manufactured by Fusion UV Systems, Inc.; valve, V valve; peak illuminance, 1,600 mW/cm²; total dose, 1,000 mJ/cm² (wavelength 380-440 nm). The illuminance of ultraviolet rays was measured using Sola-Check System manufactured by Solatell Ltd.

(Preparation of Active Energy Ray-Curable Adhesive Composition)

The components shown below were mixed and stirred at 50° C. for 1 hour to form an active energy ray-curable adhesive composition. Each component used is as follows.

(1) HEAA (hydroxyethylacrylamide) manufactured by KOHJIN Film & Chemicals Co., Ltd., which is capable of forming a homopolymer with a Tg of 123° C.

(2) ARONIX M-220 (tripropylene glycol diacrylate) manufactured by TOAGOSEI CO., LTD., which is capable of forming a homopolymer with a Tg of 69° C.

(3) ACMO (acryloylmorpholine) manufactured by KOHJIN Film & Chemicals Co., Ltd., 22.9 in SP value, which is capable of forming a homopolymer with a Tg of 150° C.

(4) Photopolymerization Initiator

KAYACURE DETX-S (diethylthioxanthone) manufactured by Nippon Kayaku Co., Ltd.

IRGACURE 907 (2-methyl-1-(4-methylthiophenyl)-2-morpholinopropane-1-one) manufactured by BASF

The active energy ray-curable adhesive composition containing 38.3 parts by weight of HEAA, 19.1 parts by weight of ARONIX M-220, 38.3 parts by weight of ACMO, 1.4 parts by weight of KAYACURE DETX-S, and 1.4 parts by weight of IRGACURE 907 was applied to two pieces of the unsaponified TAC film using MCD Coater (manufactured by FUJI MACHINE MFG. CO., LTD., cell form, honeycomb; the number of gravure roller lines, 1000/inch; rotational speed, 140% relative to line speed). The adhesive composition was applied so as to form a 0.5-μm-thick coating. The unsaponified TAC films each with the coating were bonded to both sides of the polarizer, respectively, using a roller machine. The resulting laminate was then heated to 50° C. from the unsaponified TAC film sides (both side) using an IR heater, and the ultraviolet rays were applied to both sides to cure the active energy ray-curable adhesive composition. The laminate was then air-dried at 70° C. for 3 minutes to give a polarizing film including the polarizer and the unsaponified TAC films bonded to both sides of the polarizer. The lamination was performed at a line speed of 25 m/minute.

A corona treatment (0.1 kW, 3 m/minute, 300 mm wide) was performed as an adhesion facilitating treatment on one surface of the polarizing film, where an anchor layer was to be formed (the unsaponified TAC film-side surface on which a pressure-sensitive adhesive layer was to be formed).

(Preparation of Pressure-Sensitive Adhesive Solution A)

To a reaction vessel equipped with a condenser tube, a nitrogen-introducing tube, a thermometer, and a stirrer were added 99 parts of butyl acrylate, 1.0 part of 4-hydroxybutyl acrylate, and 0.3 parts of 2,2-azobisisobutyronitrile (based on 100 parts of the solids of the monomers) together with ethyl acetate. Under a nitrogen gas stream, the mixture was allowed to react at 60° C. for 4 hours. Ethyl acetate was then added to the reaction liquid, so that a polymer solution A containing an acryl-based polymer with a weight average molecular weight of 1,650,000 was obtained (30% by weight in solid concentration). Based on 100 parts of the solid in the acryl-based polymer solution A, 0.3 parts of dibenzoyl peroxide (NYPER BMT manufactured by NOF CORPORATION), 0.1 parts of trimethylolpropane xylylene diisocyanate (Takenate D110N manufactured by Mitsui Takeda Chemicals, Inc.), and 0.2 parts of a silane coupling agent (A-100 manufactured by Soken Chemical & Engineering Co., Ltd., an acetoacetyl group-containing silane coupling agent) were added to the polymer solution A, so that an acryl-based pressure-sensitive adhesive solution A was obtained.

(Preparation of Pressure-Sensitive Adhesive Solution B) To a reaction vessel equipped with a condenser tube, a nitrogen-introducing tube, a thermometer, and a stirrer were added 94.9 parts of butyl acrylate, 5 parts of acrylic acid, 0.1 parts of 2-hydroxyethyl acrylate, and 0.3 parts of dibenzoyl peroxide (NYPER BMT40 (SV) manufactured by NOF CORPORATION) (based on 100 parts of the solids of the monomers) together with ethyl acetate. Under a nitrogen gas stream, the mixture was allowed to react at 60° C. for 7 hours. Ethyl acetate was then added to the reaction liquid, so that a polymer solution B containing an acryl-based polymer with a weight average molecular weight of 2,200,000 was obtained (30% by weight in solid concentration). Based on 100 parts of the solid in the acryl-based polymer solution B, 0.6 parts of trimethylolpropane tolylene diisocyanate (CORONATE L manufactured by Nippon Polyurethane Industry Co., Ltd.) and 0.075 part of γ-glycidoxypropylmethoxysilane (KBM-403 manufactured by Shin-Etsu Chemical Co., Ltd.) were added to the polymer solution B, so that an acryl-based pressure-sensitive adhesive solution B was obtained.

### (Preparation of Anchor Layer-Forming Coating Liquid)

A solution (Denatron B-510C (trade name) manufactured by Nagase ChemteX Corporation) containing at least 50% by weight (on a solid basis) of a urethane polymer and a solution (EPOCROS WS-700 (trade name) manufactured by NIPPON SHOKUBAI CO., LTD.) containing 10 to 70% by weight (on a solid basis) of an oxazoline group-containing acryl-based polymer and 10 to 70% by weight (on a solid basis) of a polyoxyethylene group-containing methacrylate were added to a (mixture) solution containing 100% by weight of water so that a solution having a solid concentration (base concentration) of 0.2% by weight was obtained. The prepared solution was applied to the unsaponified TAC film side of the polarizing film with a Mayer bar #5, and 5 seconds were allowed to elapse before the polarizing film was placed in a drying oven (before drying was started). Subsequently, the applied solution was dried at 50° C. for 25 seconds to form a 24-nm-thick anchor coating. The thickness of the coating before the drying was about 12 μm, which was calculated from the thickness of the dried coating. The process was performed in the atmosphere at 23° C. and 55% RH. When a Mayer bar is used for application, the thickness of the coating before drying is substantially equal to the clearance of the Mayer bar. Thus, the thickness of the coating before drying can be adjusted, as desired, to a certain extent by changing the Mayer bar number. Table 1 shows each Mayer bar number and the corresponding clearance.

TABLE 1

| Mayer bar | |
|---|---|
| number | Clearance (μm) |
| #1 | 2 |
| #2 | 5 |
| #5 | 12 |
| #7 | 17 |
| #8 | 20 |
| #11 | 28 |

(Preparation of Pressure-Sensitive Adhesive Layer-Carrying Optical Film)

The pressure-sensitive adhesive solution A was uniformly applied to the surface of a silicone release agent-treated polyethylene terephthalate film (backing) with a fountain coater, and dried for 2 minutes in an air circulation-type thermostatic oven at 155° C., so that a 20-μm-thick pressure-sensitive adhesive layer was formed on the surface of the backing. Subsequently, the pressure-sensitive adhesive layer-coated separator was bonded to the anchor layer-carrying optical film so that a pressure-sensitive adhesive layer-carrying optical film was obtained.

### Examples 2 to 12 and Comparative Examples 1 to 3

Pressure-sensitive adhesive layer-carrying optical films were prepared by the same process as in Example 1, except that the type of the transparent protective film of the optical film (polarizing film) on the side where the anchor layer was formed (on the side where the pressure-sensitive adhesive layer was formed), the base concentration, the composition of the mixed solvent, the type of the pressure-sensitive adhesive solution, and/or the binder composition was changed as shown in Table 2 (in all cases, however, the unsaponified TAC film was placed on the side opposite to the side where the pressure-sensitive adhesive layer was placed).

In Table 2, “Substrate” represents the transparent protective film on the side where the anchor layer was formed, “Dry treatment” the type of the treatment performed on the surface of the substrate where the anchor layer was to be formed, “Unsaponified TAC” an optical film made of unsaponified triacetylcellulose (manufactured by KONICA MINOLTA), “Acryl” an optical film made of lactone-modified acrylic resin, “ZEONOR” an optical film made of a norbornene resin film (manufactured by ZEON CORPORATION), “ARTON” an optical film made of a norbornene resin film (manufactured by JSR Corporation), “IPA” isopropyl alcohol, “Denatron P-580W” a solution (manufactured by Nagase ChemteX Corporation) containing 30 to 90% by weight (on a solid basis) of a urethane polymer and 10 to 50% by weight (on a solid basis) of a thiophene polymer, “Solute 1(%)” and “Solute 2(%)” each the content (% by weight) of the binder in the anchor layer-forming coating liquid, “Dry thickness (nm)” the thickness (nm) of the dry coating, and “Pressure-sensitive adhesive” the type of the pressure-sensitive adhesive solution.

The pressure-sensitive adhesive layer-carrying optical films obtained in the examples and the comparative examples were evaluated as described below. The evaluation results are shown in Table 2.

(Applied Appearance of Anchor Layer)

In each of the examples and the comparative examples, the anchor layer was applied, then dried under predetermined conditions, and visually examined for appearance immediately after the drying. The evaluation was performed according to the following criteria.

⊙: The coating has a good appearance with no repelling, coating unevenness, or contamination.

◯: Minute repelling or coating unevenness is observed, but the coating has a good appearance at such a level that visibility is not affected.

Δ: Repelling or coating unevenness is observed, but the appearance of the coating is at such a level that visibility is not affected.

x: Repelling, coating unevenness, or contamination occurs significantly, which is not acceptable for practical purposes.

(Contamination of Long Product)

On a manufacturing line, an adhesion facilitating treatment (corona or plasma treatment, 2 kW, 15 m/minute, 1.33 m wide) was performed on the surface of the polarizing film where the anchor layer was to be formed (on the unsaponified TAC film-side surface where the pressure-sensitive adhesive layer was to be placed). On the manufacturing line, the anchor layer-forming coating liquid was then applied to the polarizing film using a gravure coater so that a coating having the specific thickness shown in Table 2 before drying was formed over a length of at least 3,000 m. The coating was then dried under the specific drying conditions. The long anchor layer-carrying polarizing film was wound into a roll (roll-to-roll process). In this process, the appearance of the anchor layer after the application was visually observed over time. The evaluation was performed according to the following criteria.

⊙: The coating appearance is good with no contamination even when the coating is formed over a length of at least 3,000 m.

◯: The coating appearance has no influence on visibility although contamination slightly occurs within a length of 3,000 m.

Δ: The coating appearance has no influence on visibility although contaminants occur within a length of 3,000 m.

x: Many contaminants occur within a length of 3,000 m, which is not acceptable for practical purposes.

(Evaluation of Adhesion Between Substrate and Pressure-Sensitive Adhesive Layer (Adhesion))

The pressure-sensitive adhesive layer-carrying polarizing plate (420 mm long x 320 mm wide) obtained in each of the examples and the comparative examples was bonded to a 0.7-mm-thick non-alkali glass plate with a laminator and then autoclaved at 50° C. and 5 atm for 15 minutes so that it was completely bonded to the glass plate (the initial stage). Subsequently, the polarizing plate was peeled off by hand from the non-alkali glass plate, when the adhesion was evaluated (reworkability was evaluated) according to the following criteria.

⊙: The polarizing plate is successfully removed with no adhesive residue.

◯: The polarizing plate is successfully removed although a slight adhesive residue is observed.

Δ: Adhesive residues are observed in places, but the polarizing plate is removable.

x: The adhesive remains over at least half of the glass surface.

(Crack Resistance)

The pressure-sensitive adhesive layer-carrying polarizing plates (420 mm long x 320 mm wide) obtained in each of the examples and the comparative examples were bonded to both sides of a 0.7-mm-thick non-alkali glass plate in the crossed Nicols arrangement with a laminator. The resulting laminate was then autoclaved at 50° C. and 5 atm for 15 minutes so that they were completely bonded to the glass plate. After the resulting samples were stored under conditions at 95° C. for 500 hours, respectively, the presence or absence of cracks was visually observed according to the criteria below. The evaluation criteria were as follows.

⊙: No crack occurs.

◯: Fine cracks are slightly observed but do not affect visibility.

Δ: Fine cracks are observed in places but do not affect visibility.

x: Large cracks and fine cracks occur remarkably, which are not acceptable for practical purposes.

(Measurement of the Thickness of Anchor Layer)

Only the anchor layer was formed on the optical film using the process of preparing the pressure-sensitive adhesive layer-carrying optical film according to each of the examples and the comparative examples. The product was stained with an aqueous solution of 2% ruthenic acid for 2 minutes. The stained product was encapsulated with epoxy resin and then cut into about 80-nm-thick slices with an ultramicrotome (Ultracut S manufactured by Leica). Subsequently, the cross-section of the optical film slice was observed with a transmission electron microscope (TEM) (H-7650 manufactured by Hitachi, acceleration voltage: 100 kV), then the thickness of the anchor layer after the drying (dry thickness (nm)) was determined.

TABLE 2

| | | | | Anchor layer forming conditions | | | | | | | |
|---|---|---|---|---|---|---|---|---|---|---|---|
| | | | | | | | | | | Drying conditions | |
| | | | | | | | | | | Coating | |
| | | | | | | | | | | thickness | |
| | | | Pressure- | Composition of anchor layer-forming coating liquid | | | | | | (μm) | Drying |
| | | Dry | sensitive | | | | Base | Solute | | before | temperature |
| | Substrate | treatment | adhesive | Solvent | Solute 1 | Solute 2 | (%) | 1 (%) | Solute 2 (%) | drying | T (° C.) |
| Example 1 | Unsaponified | Corona | A | Water = | Denatron | EPOCROS | 0.2 | 0.067 | 0.133 | 12 | 50 |
| | TAC | | | 100% | B-510C | WS-700 | | | | | |
| Example 2 | Unsaponified | Corona | B | Water = | Denatron | EPOCROS | 0.2 | 0.067 | 0.133 | 12 | 50 |
| | TAC | | | 100% | B-510C | WS-700 | | | | | |
| Example 3 | Unsaponified | Corona | A | Water/IPA = | Denatron | EPOCROS | 0.2 | 0.067 | 0.133 | 12 | 50 |
| | TAC | | | 80%/20% | B-510C | WS-700 | | | | | |
| Example 4 | Unsaponified | Corona | A | Water/IPA = | Denatron | EPOCROS | 0.2 | 0.067 | 0.133 | 12 | 50 |
| | TAC | | | 65%/35% | B-510C | WS-700 | | | | | |
| Example 5 | Unsaponified | Corona | A | Water/IPA = | Denatron | EPOCROS | 0.2 | 0.067 | 0.133 | 12 | 50 |
| | TAC | | | 35%/65% | B-510C | WS-700 | | | | | |
| Example 6 | Unsaponified | Corona | A | Water/IPA = | Denatron | EPOCROS | 0.2 | 0.067 | 0.133 | 12 | 50 |
| | TAC | | | 20%/80% | B-510C | WS-700 | | | | | |
| Example 7 | Unsaponified | Plasma | A | Water/IPA = | Denatron | EPOCROS | 0.2 | 0.067 | 0.133 | 12 | 50 |
| | TAC | | | 35%/65% | B-510C | WS-700 | | | | | |
| Example 8 | Unsaponified | Corona | A | Water/IPA = | Denatron | EPOCROS | 0.4 | 0.22 | 0.18 | 12 | 50 |
| | TAC | | | 65%/35% | P-580W | WS-700 | | | | | |
| Example 9 | Acryl | Corona | A | Water/IPA = | Denatron | EPOCROS | 0.2 | 0.067 | 0.133 | 12 | 50 |
| | | | | 35%/65% | B-510C | WS-700 | | | | | |
| Example 10 | ZEONOR | Corona | A | Water/IPA = | Denatron | EPOCROS | 0.2 | 0.067 | 0.133 | 12 | 50 |
| | | | | 35%/65% | B-510C | WS-700 | | | | | |
| Example 11 | ARTON | Corona | A | Water/IPA = | Denatron | EPOCROS | 0.2 | 0.067 | 0.133 | 12 | 50 |
| | | | | 35%/65% | B-510C | WS-700 | | | | | |
| Example 12 | Unsaponified | Corona | A | Water/IPA = | — | EPOCROS | 0.2 | 0 | 0.2 | 12 | 50 |
| | TAC | | | 35%/65% | | WS-700 | | | | | |
| Comparative | Unsaponified | Corona | A | Water/IPA = | Denatron | EPOCROS | 0.2 | 0.067 | 0.133 | 12 | 50 |
| Example 1 | TAC | | | 60%/40% | B-510C | WS-700 | | | | | |
| Comparative | Unsaponified | Corona | A | Water/IPA = | Denatron | EPOCROS | 0.2 | 0.067 | 0.133 | 12 | 50 |
| Example 2 | TAC | | | 50%/50% | B-510C | WS-700 | | | | | |
| Comparative | Unsaponified | Corona | A | Water/IPA = | Denatron | EPOCROS | 0.2 | 0.067 | 0.133 | 12 | 50 |
| Example 3 | TAC | | | 40%/60% | B-510C | WS-700 | | | | | |

| | Anchor layer forming conditions | | | | | | | |
|---|---|---|---|---|---|---|---|---|
| | Drying conditions | | | | | | | |
| | | | Time until | | | | | |
| | Drying | | the start | Dry | | Contamination | | |
| | time H | | of | thickness | Coatability | of long | | Crack |
| | (s) | T × H | drying | (nm) | (appearance) | product | Adhesion | (95° C.) |
| Example 1 | 25 | 1250 | 5 | 24 | Δ | ◯ | ⊙ | ⊙ |
| Example 2 | 25 | 1250 | 5 | 24 | Δ | ◯ | ◯ | ⊙ |
| Example 3 | 25 | 1250 | 5 | 24 | ◯ | ◯ | ⊙ | ⊙ |
| Example 4 | 25 | 1250 | 5 | 24 | ⊙ | Δ | ⊙ | ⊙ |
| Example 5 | 25 | 1250 | 5 | 24 | ⊙ | Δ | ⊙ | ⊙ |
| Example 6 | 25 | 1250 | 5 | 24 | ⊙ | ◯ | ⊙ | ⊙ |
| Example 7 | 25 | 1250 | 5 | 24 | ⊙ | ◯ | ⊙ | ⊙ |
| Example 8 | 25 | 1250 | 5 | 48 | ⊙ | Δ | ⊙ | ⊙ |
| Example 9 | 25 | 1250 | 5 | 24 | ⊙ | ◯ | ⊙ | ⊙ |
| Example 10 | 25 | 1250 | 5 | 24 | ⊙ | ⊙ | ⊙ | ⊙ |
| Example 11 | 25 | 1250 | 5 | 24 | ⊙ | ⊙ | ⊙ | ⊙ |
| Example 12 | 25 | 1250 | 5 | 24 | ⊙ | Δ | ◯ | ⊙ |
| Comparative | 25 | 1250 | 5 | 24 | ⊙ | X | ⊙ | ⊙ |
| Example 1 | | | | | | | | |
| Comparative | 25 | 1250 | 5 | 24 | ⊙ | X | ⊙ | ⊙ |
| Example 2 | | | | | | | | |
| Comparative | 25 | 1250 | 5 | 24 | ⊙ | X | ⊙ | ⊙ |
| Example 3 | | | | | | | | |

What is claimed is:

1. A method for producing a pressure-sensitive adhesive layer-carrying optical film comprising an optical film, an anchor layer, and a pressure-sensitive adhesive layer placed on at least one side of the optical film with the anchor layer interposed therebetween, the method comprising at least:
an adhesion facilitating treatment step comprising performing an adhesion facilitating treatment on a surface of the optical film where the anchor layer is to be formed, before a step of forming the anchor layer is performed; and
an application step comprising applying an anchor layer-forming coating liquid to the surface of the optical film having undergone the adhesion facilitating treatment, wherein the anchor layer-forming coating liquid contains a mixed solvent, a binder resin, and a polyoxyalkylene group-containing polymer, and
the mixed solvent contains 65 to 100% by weight of water and 0 to 35% by weight of an alcohol or contains 0 to 35% by weight of water and 65 to 100% by weight of an alcohol.

2. The method according to claim 1, wherein the binder resin is a polyurethane resin binder.

3. The method according to claim 1, wherein the surface of the optical film where the anchor layer is to be formed is made of unsaponified triacetylcellulose.

4. The method according to claim 1, wherein the application step is followed by an anchor layer forming step comprising drying the coating liquid under conditions satisfying both of the following requirements: (1) the drying temperature T is between 40° C. and 70° C.; and (2) the value (T×H) obtained by multiplying the drying temperature T (° C.) by the drying time H (seconds) satisfies the relation 400≦(T×H)≦4,000 so that the mixed solvent is removed when the anchor layer is formed.

5. The method according to claim 4, wherein there is a time period of at most 30 seconds between applying the anchor layer-forming coating liquid to the optical film and starting the drying.

6. The method according to claim 1, wherein the pressure-sensitive adhesive layer-carrying optical film is a pressure-sensitive adhesive layer-carrying polarizing film.

7. A pressure-sensitive adhesive layer-carrying optical film comprising a product produced by the method according to claim 1.

8. An image display device comprising the pressure-sensitive adhesive layer-carrying optical film according to claim 7.
